(19) United States
(12) Patent Application Publication
(10) Pub. No.: US 2026/0212466 A1
(43) Pub. Date: Jul. 23, 2026

(54) SEAMLESS TILE BLENDING WITH LINEAR MATCHING

(71) Applicant: Samsung Electronics Co., Ltd., Suwon-si (KR)

(72) Inventors: Long Nguyen Le, Garland, TX (US); Tyler Luu, Richardson, TX (US); Hamid Rahim Sheikh, Allen, TX (US)

(21) Appl. No.: 19/409,154

(22) Filed: Dec. 4, 2025

Related U.S. Application Data
(60) Provisional application No. 63/746,726, filed on Jan. 17, 2025.

(51) Int. Cl. G06T 5/77; G06T 3/40

(52) U.S. Cl. CPC G06T 5/77; G06T 3/40

(57) ABSTRACT

A method includes receiving an input image and generating a target image using the input image. Generating the target image includes, for each tile of a plurality of tiles of the input image, processing the tile to obtain an incoming tile, modifying the incoming tile by applying scaling and offset coefficients, for each pixel in the target image that overlaps with a previous tile in the target image, updating the pixel in the target image with a combination of a pixel value of the pixel in the target image and a pixel value of a first corresponding pixel from the modified incoming tile, and for each pixel in the target image that corresponds to the tile and that does not overlap with the previous tile, updating the target image by filling in each such pixel in the target image with a second corresponding pixel from the modified incoming tile.

### CROSS-REFERENCE TO RELATED APPLICATION AND PRIORITY CLAIM

This application claims priority under 35 U.S.C. § 119(e) to U.S. Provisional Patent Application No. 63/746,726 filed on Jan. 17, 2025, which is hereby incorporated by reference in its entirety.

### TECHNICAL FIELD

This disclosure relates generally to image processing systems and processes. More specifically, this disclosure relates to seamless tile blending with linear matching.

### BACKGROUND

Due to hardware constraints such as limited memory, images are often processed in tiles before being assembled together. However, various shortcomings exist. For example, tile processing operations can introduce variations such as variations in brightness from tile to tile, thus creating hard seam artifacts when the tiles are assembled together.

### SUMMARY

This disclosure relates to a seamless tile blending with linear matching.

In a first embodiment, a method includes receiving, using at least one processing device of an electronic device, an input image. The method further includes generating, using the at least one processing device, a target image using the input image. Generating the target image using the input image includes, for each tile of a plurality of tiles of the input image, processing the tile to obtain an incoming tile, modifying the incoming tile by applying scaling and offset coefficients to the incoming tile, for each pixel in the target image that corresponds to the tile and that overlaps with a previous tile in the target image, updating the pixel in the target image with a combination of a pixel value of the pixel in the target image and a pixel value of a first corresponding pixel from the modified incoming tile, and for each pixel in the target image that corresponds to the tile and that does not overlap with the previous tile, updating the target image by filling in each such pixel in the target image with a second corresponding pixel from the modified incoming tile.

In a second embodiment, an electronic device includes at least one processing device configured to receive an input image. The at least one processing device is also configured to generate a target image using the input image. To generate the target image using the input image, for each tile of a plurality of tiles of the input image, the at least one processing device is also configured to process the tile to obtain an incoming tile, modify the incoming tile by an application of scaling and offset coefficients to the incoming tile, for each pixel in the target image that corresponds to the tile and that overlaps with a previous tile in the target image, update the pixel in the target image with a combination of a pixel value of the pixel in the target image and a pixel value of a first corresponding pixel from the modified incoming tile, and for each pixel in the target image that corresponds to the tile and that does not overlap with the previous tile, update the target image by filling in each such pixel in the target image with a second corresponding pixel from the modified incoming tile.

Any single one or any combination of the following features may be used with the first or second embodiment. Modifying the incoming tile may include obtaining a first set of pixels that corresponds to pixels of the incoming tile that overlap with a location of the previous tile in the target image, obtaining a second set of pixels that corresponds to pixels of the previous tile in the target image that overlap with a location corresponding to the tile in the target image, and obtaining the scaling and offset coefficients based on the first set of pixels and the second set of pixels. Linear matching may be performed between the first set of pixels and the second set of pixels to obtain the scaling and offset coefficients. Performing the linear matching may include minimizing a sum of a total squared error between pairs of pixels from the first set of pixels and the second set of pixels. Each of the pairs of pixels may be co-located pixels in the first set of pixels and the second set of pixels. Minimizing the sum of the total squared error between the pairs of pixels can reduce an error between the pairs of pixels. The linear matching can be performed for a red (R) channel, a blue (B) channel, and a green (G) channel separately such that the scaling and offset coefficients include coefficients for each of the R channel, the B channel, and the G channel. Modifying the incoming tile can include applying the coefficients for each of the R channel, the B channel, and the G channel on a pixel-wise basis to the incoming tile. Processing the tile to obtain the incoming tile can include processing the tile using an image signal processing pipeline of the electronic device. The combination of the pixel value of the pixel in the target image and the pixel value of the first corresponding pixel from the modified incoming tile is an average.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example tiling of an image that has been tiled in accordance with this disclosure;

FIG. 3 illustrates an example image that includes soft seam artifacts;

FIGS. 4A-4C illustrate an example tile blending process in accordance with this disclosure;

FIG. 5 illustrates an example target image that is partially reconstructed in accordance with this disclosure;

FIGS. 6A and 6B illustrate example tile processing sequences in accordance with this disclosure; and

FIG. 7 illustrates an example method for seamless tile blending with linear matching in accordance with this disclosure.

### DETAILED DESCRIPTION

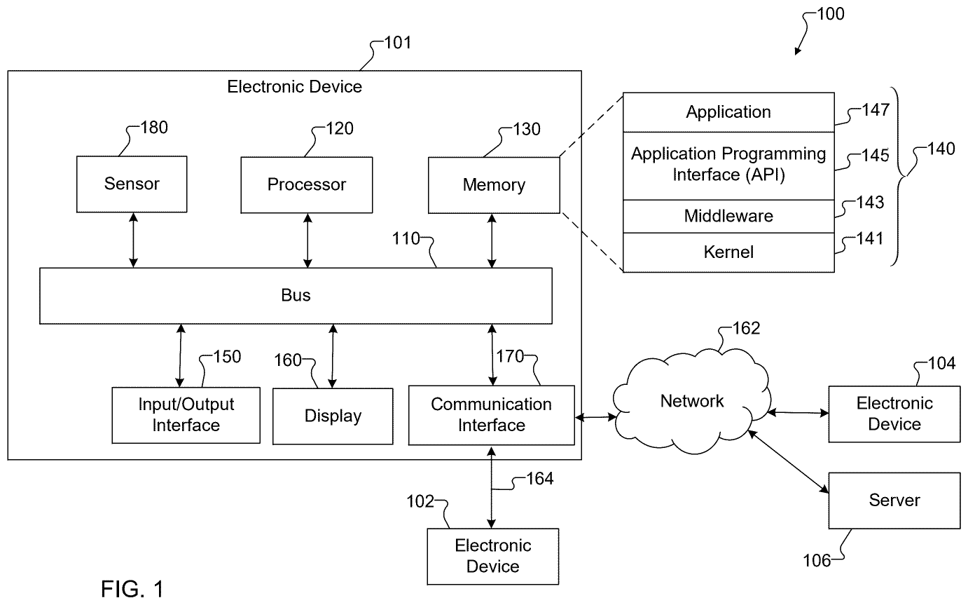

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, due to hardware constraints such as limited memory, images are often processed in tiles before being assembled together. However, various shortcomings exist. For example, tile processing operations can introduce variations such as variations in brightness from tile to tile, thus creating hard seam artifacts when the tiles are assembled together. While simple blending along tile boundaries can help reduce the hard seam, tile brightness variation can still be observable as a soft seam artifact.

To overcome the above-described disadvantages associated tile processing and tile blending, this disclosure provides for seamless tile blending with linear matching. In various embodiments, linear matching on neighboring tiles is performed on overlapping pixels of the neighboring tiles before blending the tiles back together again. As described in this disclosure, this can include passing a tile from an input image through an image signal processing (ISP) pipeline to obtain an incoming tile. A first set of pixels of the incoming tile that overlap with a location of a previous tile in a target (output) image and a second set of pixels of the previous tile in target image that overlap with a location of the currently-processed tile in the target image are retrieved and linear matching is performed between the first set of pixels and the second set of pixels to obtain scaling and offset coefficients.

In various embodiments, the incoming tile is modified by applying the scaling and offset coefficients to the incoming tile. As at least a part of generating the target (output) image, for pixels of the currently-processed tile (n^{th} tile) in the target image that overlap with the previous tile ((n−1)^{th} tile) in the target image, each such pixel in the target image is updated with a combination (e.g., an average) of the corresponding pixel value from the modified incoming tile and a current pixel value in the target image. For pixels of the currently-processed tile (n^{th} tile) in the target image that do not overlap with the previous tile ((n−1)^{th} tile) in the target image, the target image is updated by filling in each such pixel with the corresponding pixel from the modified incoming tile.

The various embodiments of this disclosure minimize the pixel-wise error between common pixels in a target image and processed incoming tiles from an input image by utilizing the above-described modified incoming tile to replace pixels in overlapping regions of the target image. The processes of this disclosure have been found to significantly reduce or eliminate tile artifacts in output images.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. It will be understood that the principles of this disclosure may be implemented using any number of devices. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to seamless tile blending with linear matching

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to seamless tile blending with linear matching. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to seamless tile blending with linear matching.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

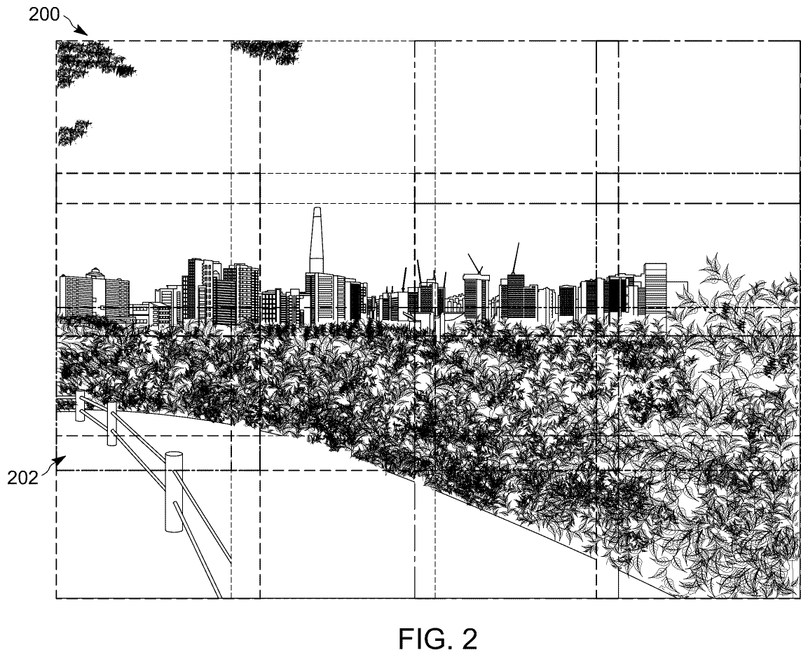

As noted above, due to hardware constraints such as limited memory, images are often processed in tiles before being assembled together. For example, FIG. 2 illustrates an example tiling of an image 200 that has been tiled in accordance with this disclosure. For ease of explanation, tiling such as shown in FIG. 2 can be performed using the electronic device 101 in the network configuration 100 of FIG. 1. However, the tiling can be performed using any other suitable electronic device(s), such as the server 106, and in any other suitable system(s).

As shown in FIG. 2, the image 200 is tiled by dividing the image 200 into a plurality of tiles, such as 16 tiles, i.e., in a 4×4 format. As illustrated in FIG. 2, each tile is shown within a bounding box. In tile-based processing, there is some overlap 202 between adjacent tiles, such as shown in FIG. 2. The tiles are subsequently processed independently by the same image signal processing (ISP) pipeline before being put back together to form a final output image.

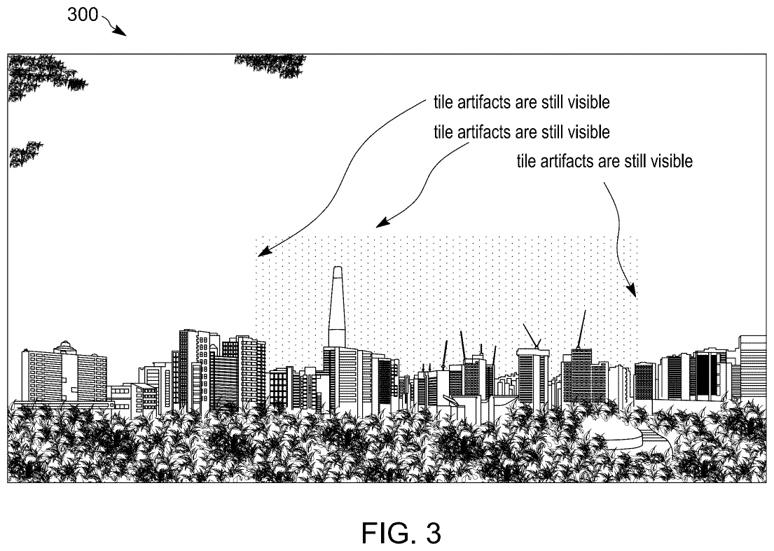

However, tile processing operations can introduce variations such as variations in brightness from tile to tile, thus creating hard seam artifacts when the tiles are assembled together. While simple blending along tile boundaries can help reduce the hard seam, tile brightness variation can still be observable as a soft seam artifact. FIG. 3 illustrates an example image 300 that includes soft seam artifacts as a result of previous approaches to tile processing that results in such artifacts appearing in overlapping areas between neighboring tiles.

To overcome the above-described disadvantages associated tile processing and tile blending, this disclosure provides for seamless tile blending with linear matching. In various embodiments of this disclosure, linear matching on neighboring tiles is performed on overlapping pixels of the neighboring tiles before blending the tiles back together again.

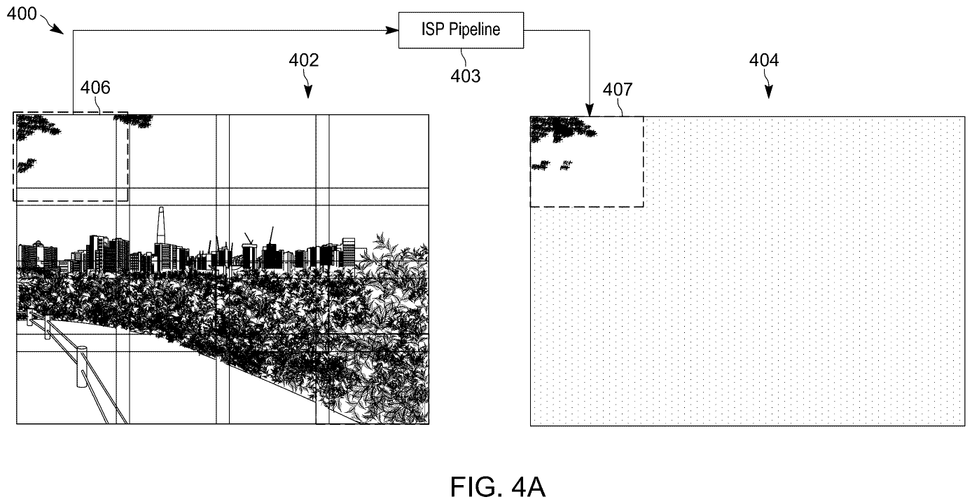

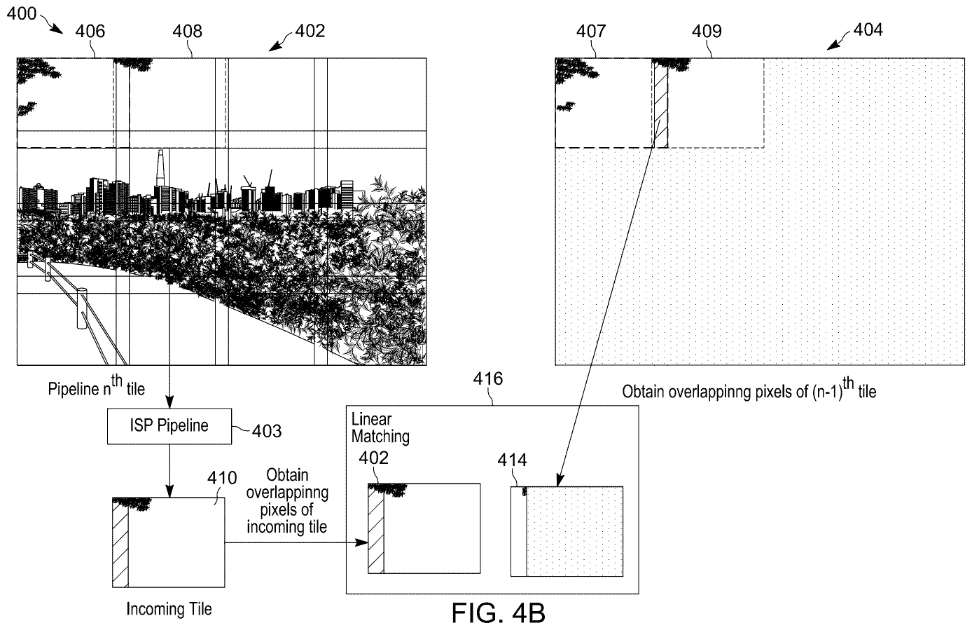

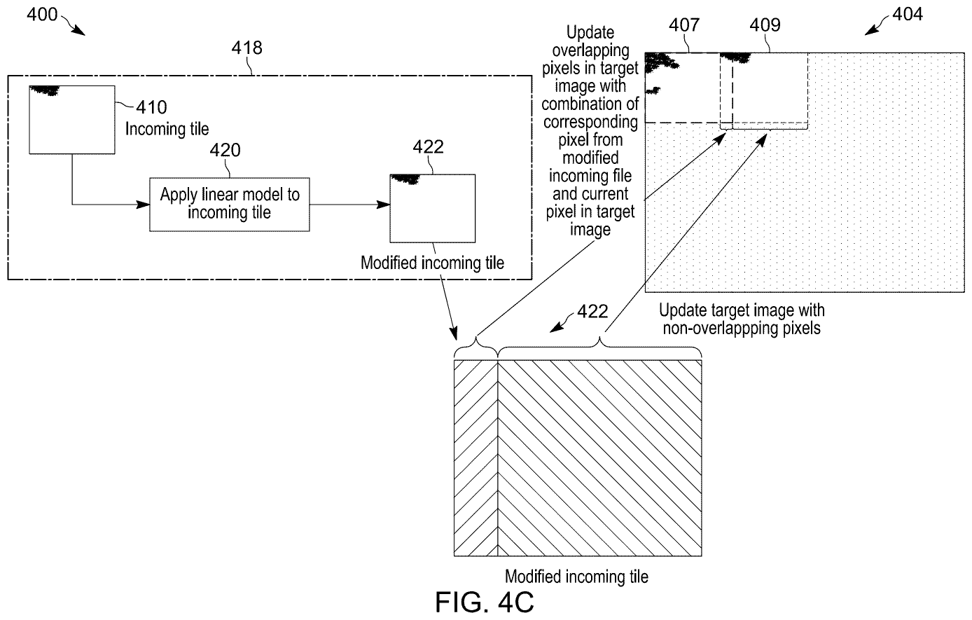

FIGS. 4A-4C illustrate an example tile blending process 400 in accordance with this disclosure. For ease of explanation, the process 400 is described as involving the use of the electronic device 101 in the network configuration 100 of FIG. 1. However, the process 400 may be used with any other suitable electronic device (such as the server 106) or a combination of devices (such as the electronic device 101 and the server 106) and in any other suitable system(s).

As shown in FIG. 4A, an input image 402 can be captured, such as using one or more cameras or other imaging sensors for capturing images of scenes, such as one or more cameras or other imaging sensors of the electronic device 101. The input image 402 is divided into tiles. In this example, the input image 402 is divided into 16 tiles (a 4×4 format), but it will be understood that other tiling formats can be used. Each tile is processed by an ISP pipeline 403, and processed tiles are reconstructed into a target image 404. Once all tiles from the input image 402 are processed, the target image 404 can be provided as a final output image.

FIG. 4A shows that a first input tile 406 from the input image 402 is processed using the ISP pipeline 403, and the tile is reconstructed in the target image 404 as a first output tile 407. For each tile processed after the first input tile 406, tile blending is performed to reduce visual artifacts in areas that overlap between tiles. For instance, as shown in FIG. 4B, a second input tile 408 is passed from the input image 402 through the ISP pipeline to obtain an incoming tile 410. As also shown in FIG. 4B, an image 412 including a first set of pixels of the incoming tile 410 that overlap with a location of a previous tile in the target image 404 and an image 414 including a second set of pixels of the previous tile 407 in the target image 404 that overlap with a location of currently-processed tile 409 in the target image 404 are retrieved. A linear matching operation 416 is performed between the first set of pixels and second set of pixels to obtain scaling and offset coefficients.

In various embodiments, the linear matching operation 416 is performed to find optimal scaling and offset coefficients (a, b) based on a specified objective. For example, based on the sets of pixels retrieved, the following noisy linear model (ε is the noise) is assumed for the relationship between a set of ref pixels (R) and a set of non-ref ones (N), where N represents the first set of pixels from the image 412 of the pixels from the incoming tile 410 (the n^{th} tile) that overlaps with the (n−1)^{th} tile, and where R represents the second set of pixels from the image 414 (the (n−1)^{th} tile) from the target image 404 that overlaps with the incoming tile 410 (the n^{th} tile). The pixels R are thus a set of reference pixels of the (n−1)^{th} tile in the target image 404, and pixels N the non-reference pixels from the incoming tile 410. The reference pixels can thus be expressed as follows.

$${r}_{i} = a \cdot {n}_{i} + b + {ε}_{i}$$

Here, rᵢ and nᵢ are the i^{th} co-located pixels in the set of ref pixels R and the set of non-ref pixels N, respectively, εᵢ is the error between pixel rᵢ and pixel nᵢ, and a and b are the scaling coefficient and offset coefficient, respectively.

As noted above, the coefficients a and b are to be estimated from these pixels based on an objective. For example, the objective can be the minimization of the sum of the total square error between all pairs of pixels (rᵢ, nᵢ). This can be expressed as follows.

$${min}_{a , b} {\sum }_{i} {( {r}_{i} - a \cdot {n}_{i} - b )}^{2}$$

In various embodiments, the linear matching is performed for the red (R), green (G), and blue (B) channels separately, resulting in coefficients (a_{R}, b_{R}) for the R channel, (a_{G}, b_{G}) for the G channel, (a_{B}, b_{B}) for the B channel. It will be understood that any suitable optimization process can be used to find the optimal sets of coefficients (a_{R}, b_{R}), (a_{G}, b_{G}), (a_{B}, b_{B}).

As shown in FIG. 4C, in various embodiments, a modification operation 418 takes as input the incoming tile 410 and modifies, at step 420, the incoming tile by applying the linear model (the scaling and offset coefficients) to the incoming tile 410 to provide a modified incoming tile 422. In various embodiments, the scaling and offset coefficients are obtained for each channel (a_{R}, b_{R}) for the R channel; (a_{G}, b_{G}) for the G channel; (a_{B}, b_{B}) for the B channel, and the coefficients are applied (on a pixel-wise basis) on the incoming tile 410 for R, G, B channels to obtain modified incoming tile 422. Performing the linear matching operation 416 serves to reduce the pixel-wise differences (error) between the common pixels in the target image 404 and the incoming tile 410. That is, by applying the optimized coefficients to the incoming tile 410, the resulting modified incoming tile 422 has a significantly reduced pixel-wise difference between common pixels in the target image 404 compared to the original incoming tile 410.

As also shown in FIG. 4C, as at least a part of generating the target (output) image, for pixels of the currently-processed tile 409 (n^{th} tile) in the target image 404 that overlap with the previous tile 407 ((n−1)^{th} tile) in the target image 404, each such pixel in the target image 404 is updated with a combination (e.g., an average, mean, median, etc.) of the corresponding pixel value from the modified incoming tile 422 and a current pixel value in the target image 404. For pixels of the currently-processed tile 409 (n^{th} tile) in the target image 404 that do not overlap with the previous tile 407 ((n−1)^{th} tile) in the target image 404, the target image 404 is updated by filling in each such pixel with the corresponding pixel from the modified incoming tile 422.

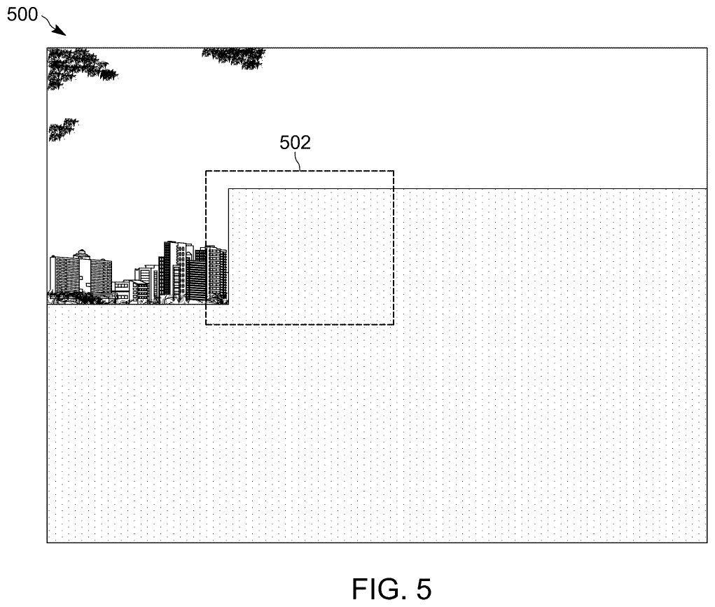

It will be understood that the above described process 400 can be repeated for each iteration after the second iteration described above for each successive tile from the input image 402 until the target image 404 is fully formed. For example, FIG. 5 illustrates an example target image 500 that is partially reconstructed in accordance with this disclosure. As shown in FIG. 5, a plurality of tiles, in this case in which the tiling is in a 4×4 format, 5 tiles, have been processed and added to the target image 500. A sixth tile 502, is therefore, the next to be processed, and the processing as described with respect to the process 400 of FIGS. 4A-4C continues until the entire target image 500 is formed. It will also be understood that some tiles may have more than one overlapping portion. For instance, the tile 502 shown in FIG. 5 overlaps a portion of both the previously processed second tile and the previously processed fifth tile. In various embodiments, the linear matching described in the process 400 can be performed for both overlapping portions of the tile 502.

Although FIGS. 4A-4C illustrate one example of a tile blending process 400, various changes may be made to FIGS. 4A-4C. For example, various components and functions in FIGS. 4A-4C may be combined, further subdivided, replicated, or rearranged according to particular needs. Also, one or more additional components and functions may be included if needed or desired. Moreover, while shown as a series of steps, various steps in FIGS. 4A-4C could overlap, occur in parallel, occur in a different order, or occur any number of times (including zero times). Also, while FIGS. 4A-4C the images 402 and 404 include particular content or a particular scene, it will be understood that the images 402 and 404 are merely examples, and the images could be of any content or scene.

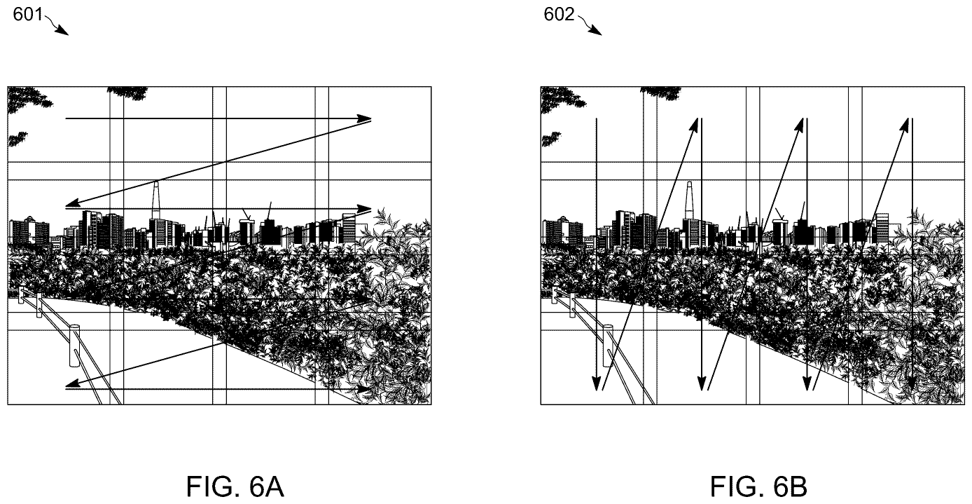

Further, it will be understood that the order of processing of the tiles can vary as needed or desired. For example, FIGS. 6A and 6B illustrate example tile processing sequences in accordance with this disclosure. FIG. 6A illustrates a first tile processing sequence 601 in which tiles are processed left to right. FIG. 6B illustrates a second tile processing sequence 602 in which tiles are processed top to bottom. It will be understood that other sequences can be used without departing from the scope of this disclosure.

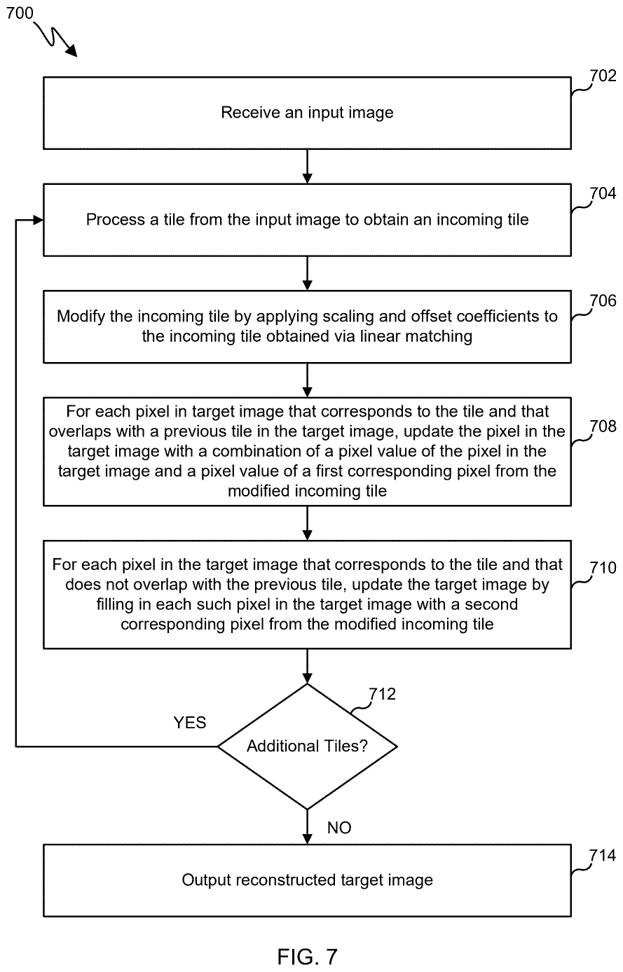

FIG. 7 illustrates an example method 700 for seamless tile blending with linear matching in accordance with this disclosure. For ease of explanation, the method 700 shown in FIG. 7 is described as being performed using the electronic device 101 in the network configuration 100 of FIG. 1. However, the method 700 could be performed using any other suitable device(s), such as the server 106, and in any other suitable system(s).

At step 702, an input image is received. This can include a processor, such as the processor 120, receiving data concerning an image captured using one or more camera or image sensor devices, such as those described with respect to the electronic device 101. As described in this disclosure, the input image is subjected to a tiling process to generate a target image using the input image. A first tile of the input image can be processed by an ISP pipeline to reconstruct a portion of the target image corresponding to the first tile. Steps 704-710 shown in FIG. 7 can then be performed for the second and all subsequent tiles.

At step 704, a tile from the input image is processed to obtain an incoming tile. In various embodiments, the tile is processed at step 704 using an ISP pipeline, such as an ISP pipeline implemented on the electronic device 101. At step 706, this incoming tile is modified by an application of scaling and offset coefficients to the incoming tile. This can include the processor 120 performing linear matching, such as the linear matching operation 416 described with respect to FIGS. 4A-4C, to obtain the scaling coefficient and the offset coefficient.

As described in this disclosure, in various embodiments, modifying the incoming tile, can include obtaining a first set of pixels that corresponds to pixels of the incoming tile that overlap with a location of the previous tile in the target image, obtaining a second set of pixels that corresponds to pixels of the previous tile in the target image that overlap with a location corresponding to the tile in the target image, and obtaining the scaling and offset coefficients based on the first set of pixels and the second set of pixels by performing the linear matching.

As also described in this disclosure, the linear matching can be performed between the first set of pixels and the second set of pixels to obtain the scaling and offset coefficients. In various embodiments, to perform the linear matching a sum of a total squared error between pairs of pixels from the first set of pixels and the second set of pixels is minimized. In various embodiments, each of the pairs of pixels are co-located pixels in the first set of pixels and the second set of pixels. As described in this disclosure, minimizing the sum of the total squared error between the pairs of pixels reduces an error between the pairs of pixels. As also described in this disclosure, the linear matching can be performed for a red (R) channel, a blue (B) channel, and a green (G) channel separately such that the scaling and offset coefficients include coefficients for each of the R channel, the B channel, and the G channel. In various embodiments, to modify the incoming tile, the coefficients are applied for each of the R channel, the B channel, and the G channel on a pixel-wise basis to the incoming tile.

At step 708, for each pixel in the target image that corresponds to the tile and that overlaps with a previous tile in the target image, the pixel in the target image is updated with a combination of a pixel value of the pixel in the target image and a pixel value of a first corresponding pixel from the modified incoming tile. In various embodiments, the combination of the pixel value of the pixel in the target image and the pixel value of the first corresponding pixel from the modified incoming tile is an average. At step 710, for each pixel in the target image that corresponds to the tile and that does not overlap with the previous tile, the target image is updated by filling in each such pixel in the target image with a second corresponding pixel from the modified incoming tile.

At step 712, it is determined whether there are still additional tiles to process from the input tile. If so, the method moves back to step 704 to process a next tile from the input image. If not, the method moves to step 714. At step 714, the reconstructed target image is output.

Although FIG. 7 illustrates one example of a method 700 for seamless blending with linear matching, various changes may be made to FIG. 7. For example, while shown as a series of steps, various steps in FIG. 7 could overlap, occur in parallel, occur in a different order, or occur any number of times (including zero times).

It should be noted that the functions shown in or described with respect to the figures can be implemented in an electronic device 101, 102, 104, server 106, or other device(s) in any suitable manner. For example, in some embodiments, at least some of the functions shown in or described with respect to the figures can be implemented or supported using one or more software applications or other software instructions that are executed by the processor 120 of the electronic device 101, 102, 104, server 106, or other device(s). In other embodiments, at least some of the functions shown in or described with respect to the figures can be implemented or supported using dedicated hardware components. In general, the functions shown in or described with respect to the figures can be performed using any suitable hardware or any suitable combination of hardware and software/firmware instructions. Also, the functions shown in or described with respect to the figures can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving, using at least one processing device of an electronic device, an input image; and
generating, using the at least one processing device, a target image using the input image, including, for each tile of a plurality of tiles of the input image:
processing the tile to obtain an incoming tile;
modifying the incoming tile by applying scaling and offset coefficients to the incoming tile;
for each pixel in the target image that corresponds to the tile and that overlaps with a previous tile in the target image, updating the pixel in the target image with a combination of a pixel value of the pixel in the target image and a pixel value of a first corresponding pixel from the modified incoming tile; and
for each pixel in the target image that corresponds to the tile and that does not overlap with the previous tile, updating the target image by filling in each such pixel in the target image with a second corresponding pixel from the modified incoming tile.

2. The method of claim 1, wherein modifying the incoming tile includes:
obtaining a first set of pixels that corresponds to pixels of the incoming tile that overlap with a location of the previous tile in the target image;
obtaining a second set of pixels that corresponds to pixels of the previous tile in the target image that overlap with a location corresponding to the tile in the target image; and
obtaining the scaling and offset coefficients based on the first set of pixels and the second set of pixels.

3. The method of claim 2, further comprising performing linear matching between the first set of pixels and the second set of pixels to obtain the scaling and offset coefficients.

4. The method of claim 3, wherein performing the linear matching includes minimizing a sum of a total squared error between pairs of pixels from the first set of pixels and the second set of pixels.

5. The method of claim 4, wherein each of the pairs of pixels are co-located pixels in the first set of pixels and the second set of pixels.

6. The method of claim 5, wherein minimizing the sum of the total squared error between the pairs of pixels reduces an error between the pairs of pixels.

7. The method of claim 4, wherein the linear matching is performed for a red (R) channel, a blue (B) channel, and a green (G) channel separately such that the scaling and offset coefficients include coefficients for each of the R channel, the B channel, and the G channel.

8. The method of claim 7, wherein modifying the incoming tile includes applying the coefficients for each of the R channel, the B channel, and the G channel on a pixel-wise basis to the incoming tile.

9. The method of claim 1, wherein processing the tile to obtain the incoming tile includes processing the tile using an image signal processing pipeline of the electronic device.

10. The method of claim 1, wherein the combination of the pixel value of the pixel in the target image and the pixel value of the first corresponding pixel from the modified incoming tile is an average.

11. An electronic device comprising:
at least one processing device configured to:
receive an input image; and
generate a target image using the input image, wherein, for each tile of a plurality of tiles of the input image, the at least one processing device is configured to:
process the tile to obtain an incoming tile;
modify the incoming tile by an application of scaling and offset coefficients to the incoming tile;
for each pixel in the target image that corresponds to the tile and that overlaps with a previous tile in the target image, update the pixel in the target image with a combination of a pixel value of the pixel in the target image and a pixel value of a first corresponding pixel from the modified incoming tile; and
for each pixel in the target image that corresponds to the tile and that does not overlap with the previous tile, update the target image by filling in each such pixel in the target image with a second corresponding pixel from the modified incoming tile.

12. The electronic device of claim 11, wherein, to modify the incoming tile, the at least one processing device is further configured to:
obtain a first set of pixels that corresponds to pixels of the incoming tile that overlap with a location of the previous tile in the target image;
obtain a second set of pixels that corresponds to pixels of the previous tile in the target image that overlap with a location corresponding to the tile in the target image; and
obtain the scaling and offset coefficients based on the first set of pixels and the second set of pixels.

13. The electronic device of claim 12, wherein the at least one processing device is further configured to perform linear matching between the first set of pixels and the second set of pixels to obtain the scaling and offset coefficients.

14. The electronic device of claim 13, wherein, to perform the linear matching, the at least one processing device is further configured to minimize a sum of a total squared error between pairs of pixels from the first set of pixels and the second set of pixels.

15. The electronic device of claim 14, wherein each of the pairs of pixels are co-located pixels in the first set of pixels and the second set of pixels.

16. The electronic device of claim 15, wherein minimizing the sum of the total squared error between the pairs of pixels reduces an error between the pairs of pixels.

17. The electronic device of claim 14, wherein the at least one processing device is further configured to perform the linear matching for a red (R) channel, a blue (B) channel, and a green (G) channel separately such that the scaling and offset coefficients include coefficients for each of the R channel, the B channel, and the G channel.

18. The electronic device of claim 17, wherein, to modify the incoming tile, the at least one processing device is further configured to apply the coefficients for each of the R channel, the B channel, and the G channel on a pixel-wise basis to the incoming tile.

19. The electronic device of claim 11, wherein, to process the tile to obtain the incoming tile, the at least one processing device is further configured to process the tile using an image signal processing pipeline of the electronic device.

20. The electronic device of claim 11, wherein the combination of the pixel value of the pixel in the target image and the pixel value of the first corresponding pixel from the modified incoming tile is an average.
